(19) United States
(12) Patent Application Publication
(10) Pub. No.: US 2010/0053120 A1
(43) Pub. Date: Mar. 4, 2010

(54) TOUCHSCREEN STYLUS

(76) Inventors: An-Yu CHANG, Taipei County (TW); Wei-Chin Lee, Taipei County (TW); Wen-Yuan Lee, Taipei county (TW)

Correspondence Address: Muncy, Geissler, Olds & Lowe, PLLC, P.O. BOX 1364, FAIRFAX, VA, 22038-1364, US

(21) Appl. No.: 12/203,750

(22) Filed: Sep. 3, 2008

(51) Int. Cl. G06F 3/033; G06F 3/045

(52) U.S. Cl. 345/179; 345/174

(57) ABSTRACT

A touchscreen stylus applies to a capacitive touchscreen and comprises a body being hollow and having an accommodating space thereinside, and a coil arranged inside the accommodating space and forming a current loop. The body also has an electric-conduction element at one end thereof, and the electric-conduction element is used to contact the capacitive touchscreen. The current loop induces an electric field in the coil. The touchscreen detects the induced electric filed and works out the coordinates of the point the touchscreen stylus contacts. In the present invention, the current from the touchscreen needn't flow through the user's hand, and the touchscreen stylus makes the touchscreen detect the contact point more accurately. The touchscreen stylus of the present invention overcomes the conventional problems that current has to flow through the hand and that the touchscreen is unable to correctly recognize the instructions from the stylus.

### FIELD OF THE INVENTION

The present invention relates to a touchscreen stylus, particularly to a stylus for a capacitive touchscreen.

### BACKGROUND OF THE INVENTION

Recently, the touchscreen has become an important input device and widely applied to many electronic products, such as mobile phones, PDA (Personal Digital Assistant), GPS (Global Positioning System), etc. The mainstream touchscreens include resistive touchscreens and capacitive touchscreens. The resistive touchscreen uses voltage drop to detect the coordinates. When a user touches the resistive touchscreen, the conduction state of a loop is turned on, and a voltage drop occurs. The calculator inside the touchscreen works out the proportion of the voltage drop and determines the coordinates of the touched point. The capacitive touchscreen uses charge variation to detect the coordinates. When a user touches the capacitive touchscreen, the controller of the touchscreen works out the proportion of the charge carried away by a conductor (such as the finger of the user) and determines the coordinates of the touched point.

With the trend of miniaturizing electronic products, the size of touchscreens is also decreased. A user usually needs a stylus to accurately operate a touchscreen. China patents CN2619304 and CN2577353, and a US patent U.S. Pat. No. 5,461,204 had disclosed styluses for touchscreens.

In China patents CN2619304 and CN2577353, the stylus has a casing, a nib on one end of the casing, a coil inside the casing, a battery inside the casing, a switch on the surface of the casing and connected to the coil and the battery. When a user moves the stylus to contact a touchscreen, the touchscreen receives the pressure from the nib. When the user turns on the switch of the stylus, the coil generates an induced magnetic field. The touchscreen analyzes the induced magnetic field to learn the instructions. Thus, the stylus can replace the right and left buttons of a mouse. In US patent U.S. Pat. No. 5,461,204, the stylus has a nib on one end of the stylus, a first coil and a second coil both inside the stylus and normally contacting each other. When the nib contacts a touchscreen, the nib actuates the first and second coils to separate and then generate different induced magnetic fields functioning as instructions. In the abovementioned prior arts, the induced magnetic field is generated by operating a switch or by the actuation of a nib. Therefore, the abovementioned prior arts cannot apply to capacitive touchscreens but only apply to pressure-sensing touchscreens.

The stylus for a capacitive touchscreen is used to conduct current from the capacitive touchscreen panel to the hand of a user. The capacitive touchscreen stylus has a body to be held by a user and a nib on one end thereof. The body and nib are made of an electrically-conductive material and able to conduct current from the panel to the hand. However, when the hand of the user is gloved, insulated or wetted, the conduction state is varied, and the touchscreen is thus unable to correctly recognize the instructions.

### SUMMARY OF THE INVENTION

The primary objective of the present invention is to provide a touchscreen stylus, wherein a wetted, gloved or insulated hand can also use the touchscreen stylus of the present invention to normally operate the touchscreen without decreasing the recognition capability of the touchscreen.

To achieve the abovementioned objective, the present invention proposes a touchscreen stylus applying to a capacitive touchscreen. The touchscreen stylus of the present invention comprises a hollow body having an accommodating space thereinside, and a coil arranged inside the accommodating space and forming a current loop. The body also has an electric-conduction element at one end thereof, and the electric-conduction element is electrically coupled to the coil and used to contact the capacitive touchscreen. The current loop induces an electric field in the coil. The touchscreen detects the induced electric filed and works out the coordinates of the point the touchscreen stylus contacts. The touchscreen stylus of the present invention enables the touchscreen to accurately recognize the contact point.

### BRIEF DESCRIPTION OF THE DRAWINGS

FIG. 1 is an exploded view schematically showing the structure of a touchscreen stylus according to the present invention;

FIG. 2 is a diagram schematically showing one application of the present invention;

FIG. 3 is a diagram schematically showing one embodiment of the present invention;

FIG. 4 is a diagram schematically showing another embodiment of the present invention;

FIG. 5 is a diagram schematically showing yet another embodiment of the present invention;

FIG. 6 is a diagram schematically showing a further embodiment of the present invention; and

FIG. 7 is a diagram schematically showing another application of the present invention.

### DETAILED DESCRIPTION OF THE PREFERRED EMBODIMENTS

Below, the technical contents of the present invention are described in cooperation with the drawings.

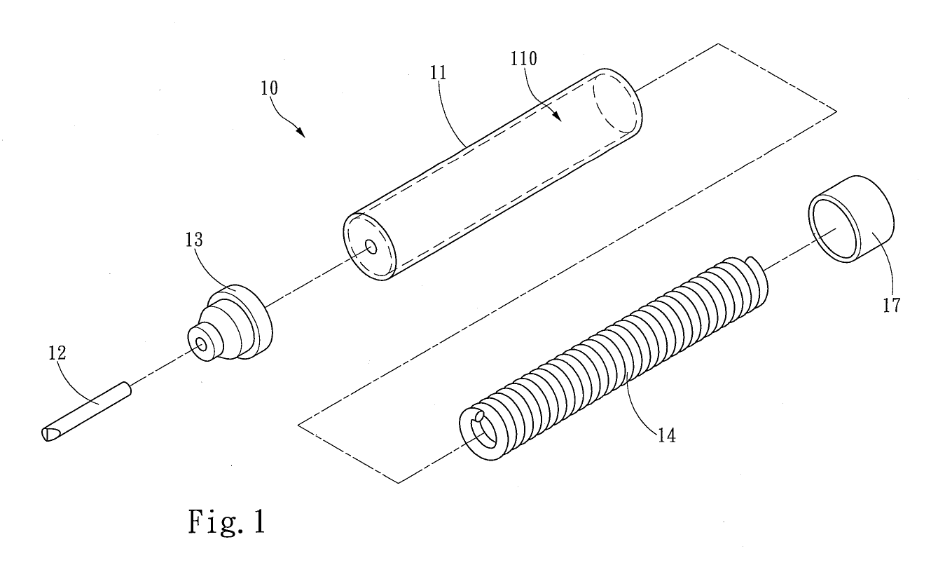

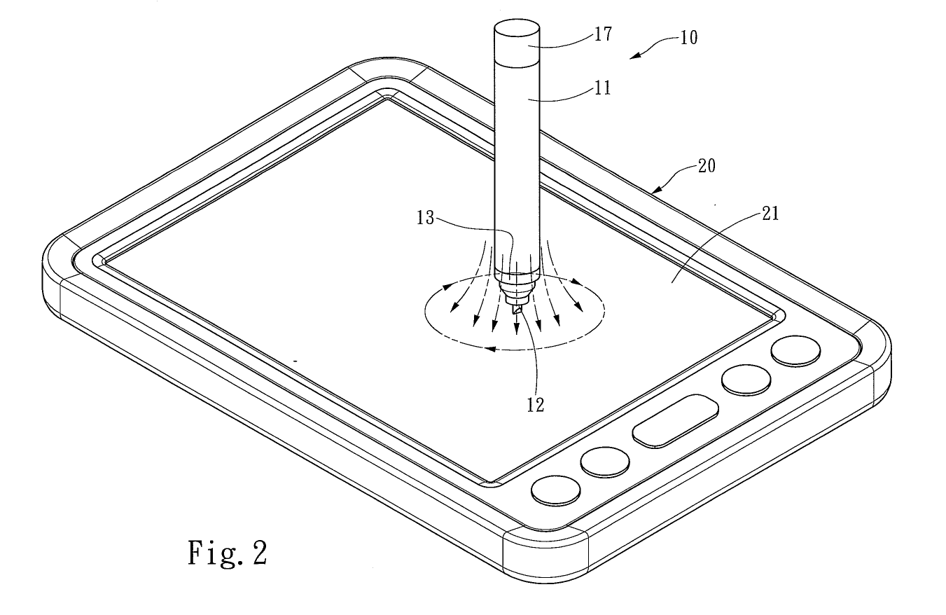

Refer to FIG. 1 and FIG. 2. The present invention proposes a touchscreen stylus applying to capacitive touchscreens, including the touchscreens 21 of electronic devices 20, such as computers, mobile phones, PDA, etc. The touchscreen stylus 10 comprises a body 11 and a coil 14. The body 11 has a hollow accommodating space 110 receiving the coil 14. One end of the body 11 has an opening, and a cover 17 is used to cover the opening. The other end of the body 11 has an electric-conduction element 12 electrically coupled to the coil 14. The electric-conduction element 12 is made of an electric-conduction rubber, an electric-conduction foamed pad, or a metallic material. The user moves the electric-conduction element 12 of the touchscreen stylus to contact the touchscreen 21 and input data or instructions. The body 11 has a buffer element 13 to buffer the contact force lest too great that a contact force make the electric-conduction element 12 scratch the touchscreen 21. When the electric-conduction element 12 contacts the touchscreen 21, a static-charge connection occurs between the electric-conduction element 12 and the transparent electrodes (not shown in the drawings) arranged on the touchscreen 21. Thus, current flows through the electric-conduction element 12 to the coil 14. In the coil 14, the current variation generates self-inductance, and the self-inductance induces an electric field on the touchscreen 21. In other words, the contact of the electric-conduction element 12 and the touchscreen 21 causes a capacitance variation, and the capacitance variation causes current to flow through the coil 14 and generate an induced electric field. Then, the touchscreen 21 recognizes the contact point from the induced electric field. Thus, the current from the touchscreen 21 needn't flow through the user's hand in the present invention. Therefore, the gloved or insulated hand will not decrease the recognition capability of the touchscreen 21.

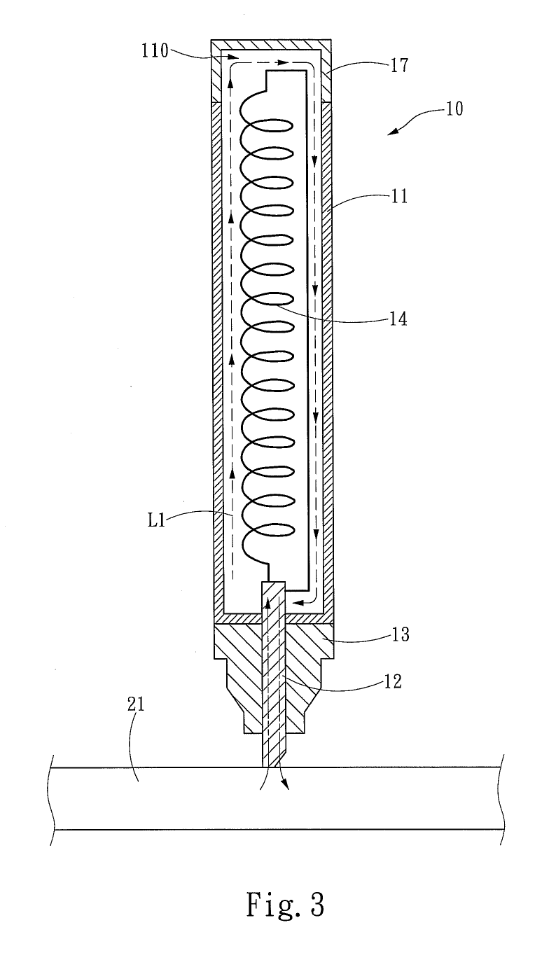

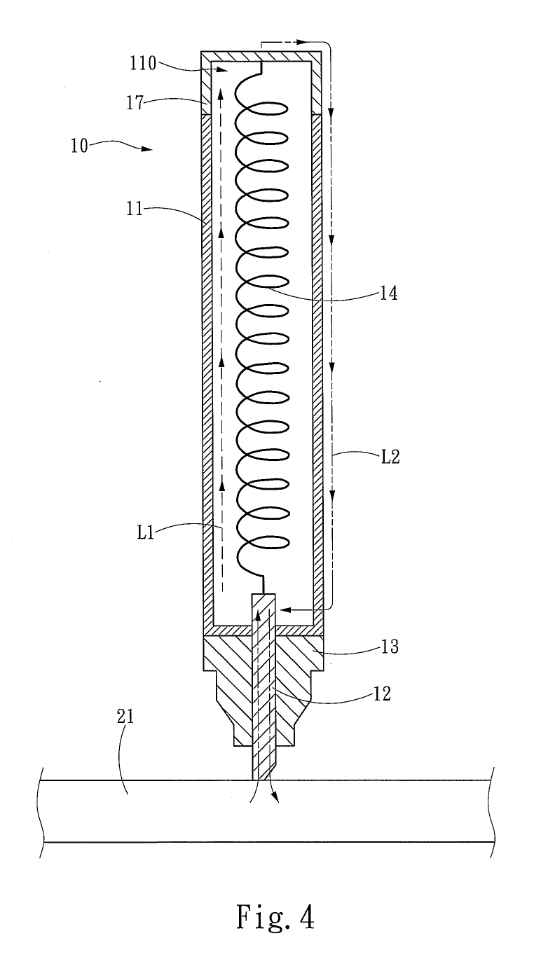

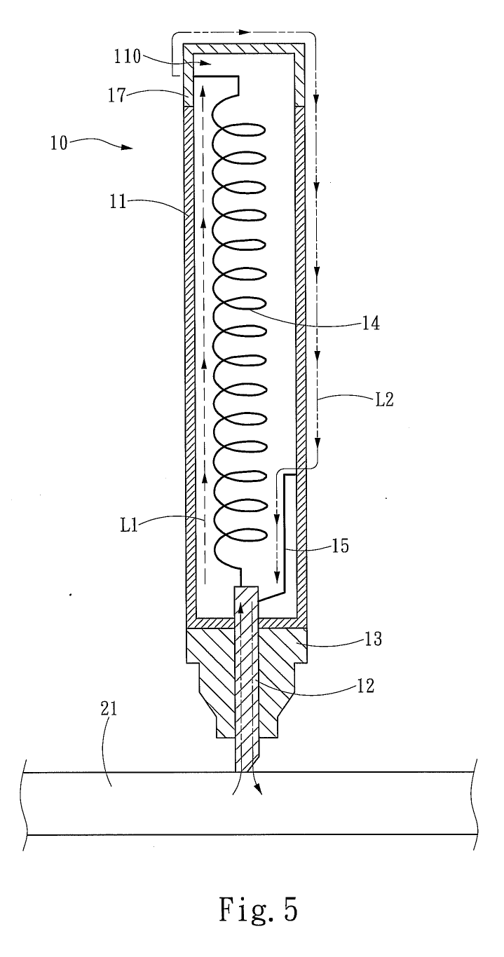

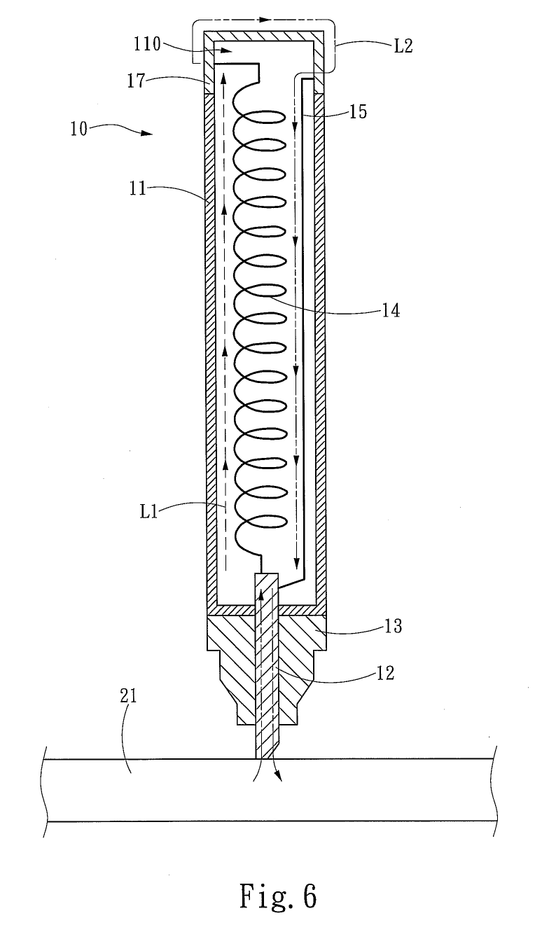

Refer to FIG. 3 for one embodiment of the present invention. As shown in FIG. 3, two ends of the coil 14 are joined to the electric-conduction element 12. The body 11 is made of an insulating material or a conductive material. The current flows from the touchscreen 21 through the electric-conduction element 12 to the coil 14 and then flows from the coil 14 through the electric-conduction element 12 back to the touchscreen 21, whereby an internal current path L1 is formed inside the touchscreen stylus 10. Refer to FIG. 4 for another embodiment of the present invention. As shown in FIG. 4, one end of the coil 14 is joined to the electric-conduction element 12, and the other end is joined to the cover 17. In this embodiment, the body 11 and the cover 17 are made of a conductive material. The current flows from the touchscreen 21 through the electric-conduction element 12 to the coil 14 and then flows from the coil 14 through the cover 17, the body 11 and the electric-conduction element 12 back to the touchscreen 21, whereby an internal current path L1 and an external current path L2 are respectively formed inside and outside the touchscreen stylus 10. Refer to FIG. 5 for yet another embodiment of the present invention. As shown in FIG. 5, a conductive wire 15 is used to connect the body 11 with the electric-conduction element 12. The current flows from the touchscreen 21 through the electric-conduction element 12 to the coil 14 and then flows from the coil 14 through the cover 17, the body 11, the conductive wire 15 and the electric-conduction element 12 back to the touchscreen 21, whereby an internal current path L1 and an external current path L2 are respectively formed inside and outside the touchscreen stylus 10. Refer to FIG. 6 for a further embodiment of the present invention. As shown in FIG. 6, two ends of the conductive wire 15 are respectively connected to the cover 17 and the electric-conduction element 12. The current flows from the touchscreen 21 through the electric-conduction element 12 to the coil 14 and then flows from the coil 14 through the cover 17, the conductive wire 15 and the electric-conduction element 12 back to the touchscreen 21 without passing through the body 11. In the abovementioned embodiments, the current variation of the coil 14 generates self-inductance in the coil 14, and the self-inductance induces an electric field on the touchscreen 21. The touchscreen 21 detects the intensity of the induced electric field and the capacitance variation in different positions to work out the coordinates of the point contacted by the touchscreen stylus 10 and the tilt angle between the touchscreen stylus 10 and the touchscreen 21.

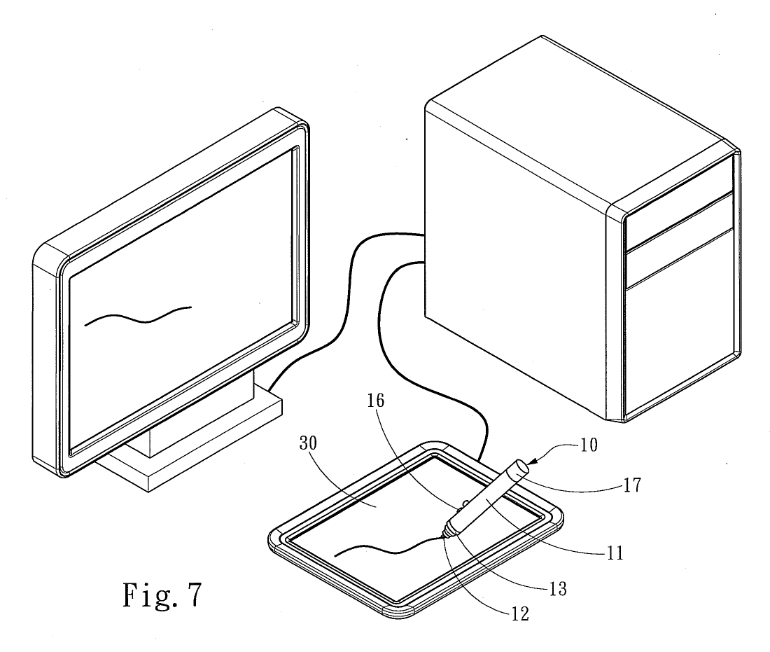

Refer to FIG. 7 for another application of the present invention. The touchscreen stylus 10 may also apply to a handwriting panel 30. The touchscreen stylus 10 has an operation button 16. When pressed down, the operation button 16 contacts the coil 14 inside the touchscreen stylus 10 and short-circuits of the coils 14. Thus, the turn number of the portion of the coil 14 the current flows through is varied, and the intensity of the induced electric field is changed. The handwriting panel 30 not only can detect the induced electric field to work out the contact point but also can generate different instructions according to the variation of the electric field intensity. As shown in FIG. 7, after a user has pressed down the operation button 16, the touchscreen stylus 10 can be used to draw a curve or input instructions to open or close a file.

In conclusion, the touchscreen stylus 10 of the present invention has an electric-conduction element 12 and a coil 14 electrically coupled to the electric-conduction element 12. When the electric-conduction element 12 contacts the touchscreen 21, the static-charge connection therebetween causes the capacitance to change. Thus, current flows from the touchscreen 21 through the electric-conduction element 12 to the coil 14. The current variation in the coil 14 induces an electric field. The touchscreen 21 works out the contact point from the position of capacitance change and the induced electric field. In the present invention, the current from the touchscreen needn't flow through the user's hand. Therefore, a gloved or insulated hand can also use the touchscreen stylus 10 of the present invention to normally operate the touchscreen without decreasing the recognition capability of the touchscreen.

The present invention is superior to the prior arts in that the touchscreen stylus of the present invention makes the touchscreen detect the contact point more accurately.

The embodiments described above are only to exemplify the present invention but not to limit the scope of the present invention. Therefore, any equivalent modification or variation according to the spirit of the present invention is to be also included within the scope of the present invention.

What is claimed is:

1. A touchscreen stylus applying to a capacitive touchscreen and comprising
a body being hollow, having an accommodating space thereinside, and having an electric-conduction element at one end thereof, wherein said electric-conduction element is used to contact said capacitive touchscreen; and
a coil arranged inside said accommodating space, electrically coupled to said electric-conduction element, receiving current from said touchscreen via said electric-conduction element to form a current loop and generate an induced electric field.

2. The touchscreen stylus according to claim 1, wherein said current loop includes an internal current path on said coil.

3. The touchscreen stylus according to claim 1, wherein two ends of said coil are joined to said electric-conduction element.

4. The touchscreen stylus according to claim 3, wherein said current loop is an internal current path on said coil.

5. The touchscreen stylus according to claim 1, wherein said body has an opening at one end thereof and has a cover used to cover said opening.

6. The touchscreen stylus according to claim 5, wherein one end of said coil is connected to said electric-conduction element, and the other end of said coil is connected to said cover.

7. The touchscreen stylus according to claim 6 further comprising a conductive wire connecting said body and said electric-conduction element.

8. The touchscreen stylus according to claim 7, wherein said current loop includes an internal current path on said coil and an external current path on said body.

9. The touchscreen stylus according to claim 6 further comprising a conductive wire connecting said cover and said electric-conduction element.

10. The touchscreen stylus according to claim 9, wherein said current loop includes an internal current path on said coil and an external current path on said body.

11. The touchscreen stylus according to claim 6, wherein said cover is made of a conductive material.

12. The touchscreen stylus according to claim 1, wherein said body is made of a conductive material.

13. The touchscreen stylus according to claim 1, wherein said body is made of an insulating material.

14. The touchscreen stylus according to claim 1, wherein said electric-conduction element is made of an electric-conduction rubber, an electric-conduction foamed pad, or a metallic material.

15. The touchscreen stylus according to claim 1 further comprising an operation button, wherein pressing down said operation button can vary the turn number of said coil and change said induced electric field.

16. The touchscreen stylus according to claim 1, wherein said body has a buffer element connected to said electric-conduction element.
